(19) United States
(12) Patent Application Publication
(10) Pub. No.: US 2014/0258610 A1
(43) Pub. Date: Sep. 11, 2014

(54) RAID Cache Memory System with Volume Windows

(71) Applicant: LSI CORPORATION, San Jose, CA (US)

(72) Inventor: Kapil Sundrani, Bangalore (IN)

(73) Assignee: LSI CORPORATION, San Jose, CA (US)

(21) Appl. No.: 13/790,503

(22) Filed: Mar. 8, 2013

Related U.S. Application Data
(60) Provisional application No. 61/774,097, filed on Mar. 7, 2013.

(51) Int. Cl. G06F 3/06

(52) U.S. Cl. CPC G06F 3/0689
USPC 711/114; 711/119

(57) ABSTRACT

The invention may be embodied in a cache memory volume windows data storage system to enable cache memory rebuilds in response to power-on-reset (POR) events. To handle POR events occurring while a flush from the cache memory to the permanent memory is taking place, the storage controller maintains duplicate copy of a volume window bitmap and a volume mark register while a portion of the cache memory unavailable due to the flush event. The second copy of the volume bit map and volume mark register concatenation are used to account for the case where a POR event occurs while the flush is in process. The firmware uses the peer drives and the applicable cache rebuild protocol (e.g., RAID) to rebuild the data for all volume windows that contain data that may have become corrupted due to a POR event occurring during cache memory flush events are in progress.

### CROSS REFERENCE

The present application claims priority under 35 U.S.C. §119 to U.S. Provisional Application Ser. No. 61/774,097 filed Mar. 7, 2013. Said U.S. Provisional Application Ser. No. 61/774,097 filed Mar. 7, 2013 is hereby incorporated by reference in its entirety.

### TECHNICAL FIELD

The present invention relates to computer memory systems, such as RAID systems and, more particularly, to a volume windows system that maintains the integrity of data stored in a disk cache memory subsystem when a power-on-reset (POR) event occurs while a cache flush operation is in process.

### BACKGROUND

A RAID computer storage system, or any other computer storage system in general, bears the responsibility of managing data and processing input-output (I/O) requests from one or more host computers supported by the computer storage system. While processing multiple host requests in parallel with background operations, it is imperative that the computer storage system maintain the integrity of the data stored in the memory system while processing and completing the host I/O requests in a reasonable amount of time.

A cache memory subsystem is often used to speed access to recently and frequently accessed data. The cache subsystem is therefore used to hold data that has frequently or recently been read or written and, in some cases, adjacent data areas that are likely to be accessed next, prior to flushing the cache data to a permanent memory. For example, a disc cache subsystem stored on attached memory devices is often used to store cache data prior to flushing the cache data to the permanent memory, which is also stored on the attached memory devices. Both read and write caching are usually provided for storing recently entered or changed data to increase read and write I/O performance. For performance reasons, it is desirable to enable cache memory transfers to provide faster access than reading and writing directly to the permanent memory, which is much larger than the cache memory (and in some cases a different type of memory) and therefore requires longer data access times. Higher levels of cache memory provided in the cache subsystem allow more data to be held in cache memory, which allows faster access to larger amount of frequently and recently accessed data.

Power-on-reset (POR) conditions should normally not occur. When they do, however, they may indicate a hardware issue either with the device or other hardware components within the system. When cache is enabled in conventional disk cache memory systems, POR conditions typically result in data loss within the cache data that had not been previously committed (flushed) to the permanent memory, but is only stored in the cache memory at the time the POR event occurs. This typically means that a future read to the blocks that were lost in the cache memory will return stale or invalid data thereby causing data corruption. For RAID arrays, many solutions to this problem take the attached memory offline to rebuild the entire volume using a new drive upon the detection of POR in order to ensure stale data is not returned to the host. Doing so has several drawbacks, however, such as requiring a long rebuild time and performance degradation.

There is, therefore, a continuing need for improved techniques for maintaining data integrity in disk cache memory systems and, more particularly, or maintaining data integrity in cache memory systems during POR conditions.

### SUMMARY

The present invention addresses these problems by utilizing a volume windows system to maintain data integrity in disk cache memory systems during power-on-reset (POR) conditions. The storage controller uses a volume bitmap and a volume mark register that directly or indirectly identify the physical memory locations of the volume windows to rebuild only those windows containing potentially corrupted data when a POR event occurs. Disk flush events occur periodically to copy the contents of the cache memory to the permanent memory. To handle POR and disk flush events, the storage controller maintains a second copy of the volume window bitmap and a second copy of the volume mark register, which record I/O that occurs while the disk flush operation is in process. The second copy is utilized to rebuild any data that could potentially become corrupted as a result of a POR event that occurs while the flush operation is in process.

When a POR event does occur while a cache flush operation is taking place, the storage controller firmware concatenates the two copies of volume window bitmap (if the second copy is non-zero indicating the presence of I/O received during the flush operation). The firmware then uses the second copy of the volume window bitmap to rebuild only the potentially corrupted windows of the disk cache as indicated by the non-zero data in the volume window bitmap. The storage controller then uses the peer cache memory devices, and the applicable rebuild protocol (e.g., RAID), to rebuild the data for only those volume windows that contain data that may have become corrupted due to the POR event that occurred while the cache memory flush event was in process.

A user interface may provide the user with the option of enabling or disabling volume windows on a per-volume basis. The user interface may also provide the user with the option of configuring the size of the volume windows (i.e., the number of stripes in each volume window) based on the desired performance requirement.

It is to be understood that both the foregoing general description and the following detailed description are exemplary and explanatory only and are not necessarily restrictive of the invention as claimed. The accompanying drawings, which are incorporated in and constitute a part of the specification, illustrate embodiments of the invention and together with the general description, serve to explain the principles of the invention.

### BRIEF DESCRIPTION OF THE FIGURES

The numerous advantages of the invention may be better understood with reference to the accompanying figures in which:

FIG. 1 is a block diagram of a computer system utilizing a cache memory RAID system with volume windows.

FIG. 2 is a block diagram of the cache memory RAID system showing the volume windows.

FIG. 3 is a volume window bitmap identifying volume windows with data requiring rebuild in response to a POR condition.

FIG. 4 is a conceptual illustration of a user interface utility that allows a user to select the number of stripes included in the windows of the volume windows system.

FIG. 5 is a conceptual illustration of a user interface utility that allows a user to enable and disable volume windows on per-volume basis.

### DETAILED DESCRIPTION OF ILLUSTRATIVE EMBODIMENTS

The invention may be embodied, as one particular example, in a RAID system that utilizes a volume windows system to enable partial rebuilds of volumes that may become corrupted by POR events on disks having dirty data that has not been committed to the media but is only in the disk cache. A volume window is a logical group of contiguous stripes of a particular logical volume, in this case a cache memory volume. Each window is represented by a rebuild bit in a volume windows bitmap that denotes whether or not any stripe in the corresponding window contains data that has not yet been flushed to the permanent memory. The rebuild bit corresponding to a volume window bitmap is set (e.g., given value=1) whenever the host writes data to any of the stripes of the corresponding cache window. The rebuild bit is then reset (e.g., given value=0) when the data in that window has been flushed to the permanent memory.

The invention may be embodied in a host computer using a RAID cache memory system utilizing the volume window system. In addition, while the cache memory may be implemented as disc cache, the invention is not limited to this particular type of cache memory. For example, it will be appreciated that cache memory volume may be implemented with solid state memory devices stored on a memory controller card (e.g., HBA), or any other suitable computer memory, such as a removable memory, cloud data storage, or computer memory located on another networked host computer that could undergo a POR.

The storage controller typically uses firmware to implement a RAID storage protocol for the cache memory volume but may utilize any other suitable memory rebuild protocol for the cache memory as a matter of design choice. Similarly, the storage controller typically implements a RAID storage protocol for the permanent memory but may use any other suitable memory rebuild protocol for the permanent memory as a matter of design choice.

The number of stripes in volume windows will ordinarily be the same for each window of a volume with each window having two or more stripes. A user interface utility is typically provided allowing a user the option of enabling volume windows on a per-volume basis and specifying the size of the volume window (i.e., the number of stripes included in each volume window) to provide the desired performance. In a two-tiered volume windows system (e.g., RAID protocol for the cache memory volume as well as RAID protocol for the permanent memory volume), the user interface utility may allow the user to enable volume windows system on a per-volume basis and specify the volume size for each tier.

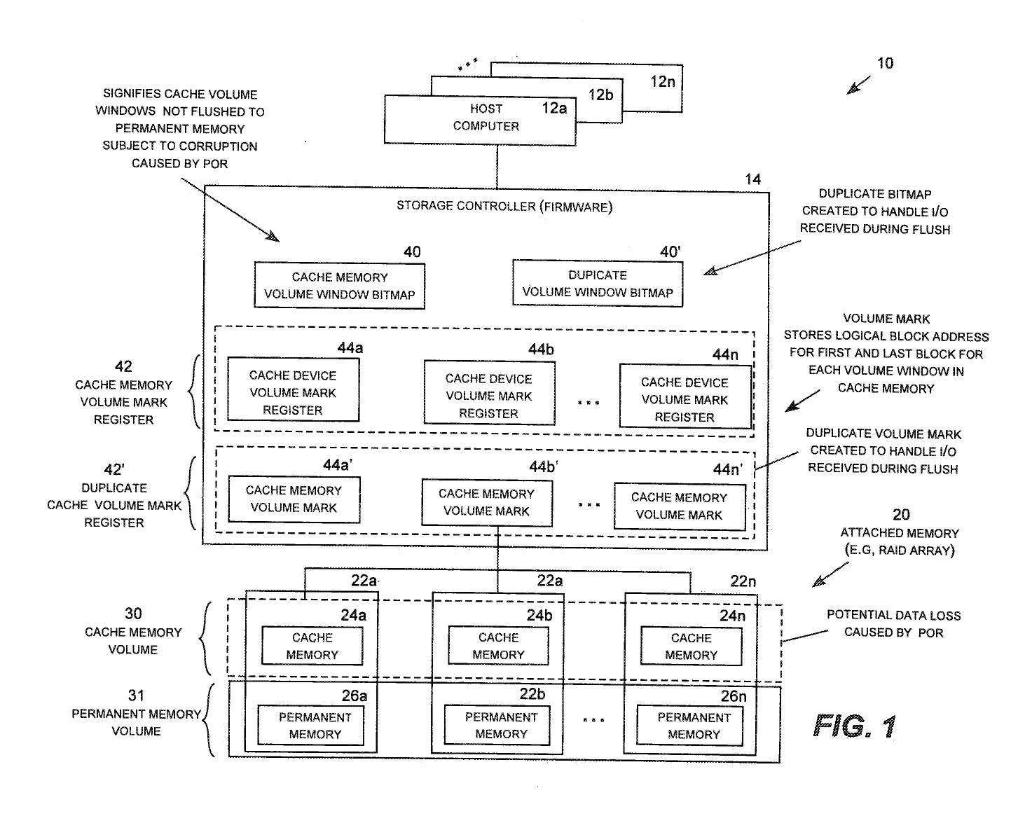

FIG. 1 is a block diagram of a host computer system 10 utilizing the volume windows system to provide an illustrative example of the invention. The host computer system 10 supports one or more host computers 12a-n. At least one of the host computers 12a-n is functionally connected (e.g., physical or wireless connection) to a memory storage controller 14, which may be deployed on a computer card, such as a host bus adapter (HBA), or in any other suitable computer location. The memory storage controller 14 supports an attached memory array 20 that includes a number of attached memory devices 22a-n. Each attached memory device has an associate cache memory, such as disc cache, and an associated permanent memory. In this example, the attached memory device 22a includes a cache memory 24a and a permanent memory 26a. Similarly, the attached memory device 22b includes a cache memory 24b and a permanent memory 26b, and so forth for each attached memory device.

The cache memories 24a-n form a cache memory volume 30, while the permanent memories 26a-n form a permanent memory volume 31.The storage controller 14 implements a memory rebuild protocol, such as a RAID protocol, for the cache memory volume 30 and may also implement a memory rebuild protocol, such as a RAID protocol, for the permanent memory volume 31. While the volume window system is described below for the cache memory volume 30, it may also be applied to the permanent memory volume 31, both separately and in combination with a volume windows system for the cache memory volume 30.

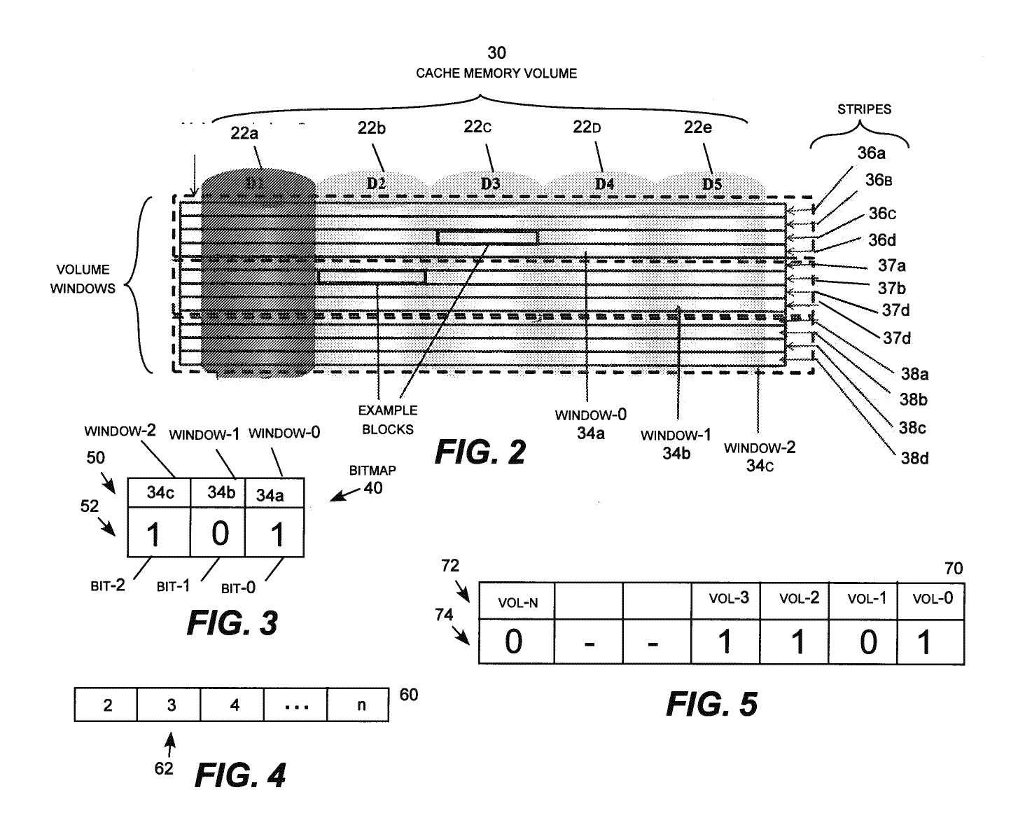

Referring to FIG. 2, in this particular example, the cache memory volume 30 includes an array of five cache memory devices 22a-e. The memory storage controller 14 logically organizes the cache memory volume 30 into a number of volume windows. This particular example includes three volumes windows denoted as volume window 34a (window-0), volume window 34b (window-1), and volume window 34c (window-2). Each volume window is divided onto an equal number of stripes, where each stripe includes at least one block from each cache memory device 22a-e. This is a four-stripe example, in which the volume window 34a (window-0) is divided into four stripes 36a-d, the volume window 34b (window-1) is divided into four stripes 37a-d, and the volume window 34c (window-2) is divided into four stripes 38a-d.

Referring again to FIG. 1, to implement the volume windows system, the storage controller 14 includes control logic, a volume rebuild bit register 40, and a volume mark register 42. The volume rebuild bit register 40 includes a set bit for each volume window of the cache array 30 indicating which volume windows contain data that has not yet been flushed to the permanent memory array 31. The volume mark register 42 includes a number of cache device volume mark registers 44a-n with each cache device volume mark register corresponding to an associated cache memory device 24a-n. The volume mark register 42 stores the logical block address (LBAs) of the first and last blocks of each window of the RAID volume that contain data that that has not been flushed to the permanent memory. The LBAs designate (directly or indirectly) the physical address locations in the cache memory device 24a-n where the data to be rebuilt is located to facilitate rebuilding any windows that may become corrupted as a result of a POR event.

FIG. 3 illustrates the volume rebuild bit register 40, which includes volume window indicators 50 and associated rebuild bits 52. Each rebuild bit corresponds to an associated window. In this example, each rebuild bit is set (given value 1) when the corresponding window contains data that has yet been flushed from the cache memory volume 30 to the physical memory volume 31. The rebuild bit is reset (given value 0) after the corresponding window has been flushed to the physical memory 31. The bit is set again whenever the firmware receives another write to this volume window, and reset again when data is written to the permanent memory. In the particular example shown in FIG. 3, only volume windows 34a (window-0) and window 34c (window-2) contain data that has not been flushed to the permanent memory 31 and, therefore, have their corresponding rebuild bits set (value=1) in the bitmap 40.

The firmware in the storage controller 14 periodically flushes the contents of the cache memory 30 to the permanent memory 31. In this illustrative embodiment, once a flush cycle starts, the firmware issues a SYNCHRONIZE CACHE SCSI command to each of the cache memory devices 22a-e participating in the volume windows rebuild feature with the Logical Block Address (LBA) set to the physical LBA equivalent of the start LBA of first window in the volume mark register 42 (window 34a [window-0] in this particular example). The storage controller 14 also sets the number of logical blocks equal to the physical equivalent of the number of blocks between the first and the last blocks of the volume window to be rebuilt (the number of blocks between volume window-0 and window-2 in this particular example). The LBAs stored in the volume mark register 42 therefore represent the first and last logical block addresses for the blocks contributing to the volume windows 34a-c to be rebuilt. Note that the volume mark register may hold the logical block addresses of the volume, which may need to be translated to get the effective physical LBA equivalent for the cache storage devices 22a-e.

Once the flush is completed, the firmware clears all of the rebuild bits in the volume window bitmap 40 and clears all of the LBA addresses from the volume mark register 42. The process then begins again, with the rebuild bits in the volume window bitmap 40 being set and the LBA addresses being stored in the volume mark register 42 as data is stored in the cache windows, until the next flush of cache memory 30 to the permanent memory 31.

While a flush operation is taking place, there can be other I/Os running on the volumes under flush. As a result, a POR event can occur while the flush operation is in process. To handle this case, the firmware maintains second copies (initially with data zeroes) of the volume window bitmap 40′ and the volume mark register 42′. The second copies are used to record any I/O occurring while the flush operation is in process. Once the flush completes the second copy 40′, 42′ becomes the primary copy for the next cycle of flush.

Whenever POR occurs, the firmware concatenates the two copies of volume window bitmap 40, 40′ (if the second copy 40′ contains non-zero indicating that data was received into the window during the flush). The firmware also concatenates the two copies of volume mark register 42, 42′. The firmware then uses the peer drives to rebuild the data for only those volume windows that have the corresponding bits set in the second copy of the volume window bitmap 40′, using the applicable RAID data rebuild protocol, to account for the case where the POR event occurred while the flush operation was in process

The user has the option of configuring the granularity of volume windows on a per-volume basis with a minimum granularity of two stripes. To allow the users to do so, the user is given an option to select the number of stripes included in the windows of the volume windows system. FIG. 4 is a conceptual illustration of a user interface utility 60 that allows the user to specify the size of the volume windows. In this example, the cursor 62 is located under user control selecting “three” in the interface utility 60 as the number of stripes to be included in each window of the volume windows system.

The user also has the option of activating the volume windows feature on a per-volume basis. To allow the users to do this, a user interface exposing an option to enable or disable volume windows on per-volume basis. FIG. 5 is a conceptual illustration of a user interface utility 70 that allows a user to enable and disable volume windows on per-volume basis. The user interface 70 includes volume indicators 72 and corresponding bits 74 which the user may set to enable “volume windows” for the corresponding window. As shown in the example shown in FIG. 5, the user has enabled “volume windows” for volume-0, volume-2, and volume-3. In a two-tiered volume windows system, the user interface utility may also include similar user interfaces to those shown in FIGS. 4 and 5 allowing the user to select the number of stripes and enabling volume windows on a per-volume basis for the permanent memory as well as the cache memory.

All of the methods described herein may include storing results of one or more steps of the method embodiments in a storage medium. The results may include any of the results described herein and may be stored in any manner known in the art. The storage medium may include any storage medium described herein or any other suitable storage medium known in the art. After the results have been stored, the results can be accessed in the storage medium and used by any of the method or system embodiments described herein, formatted for display to a user, used by another software module, method, or system, etc. Furthermore, the results may be stored “permanently,” “semi-permanently,” temporarily, or for some period of time. For example, the storage medium may be random access memory (RAM), and the results may not necessarily persist indefinitely in the storage medium.

It is further contemplated that each of the embodiments of the method described above may include any other step(s) of any other method(s) described herein. In addition, each of the embodiments of the method described above may be performed by any of the systems described herein.

Those having skill in the art will appreciate that there are various vehicles by which processes and/or systems and/or other technologies described herein can be effected (e.g., hardware, software, and/or firmware), and that the preferred vehicle will vary with the context in which the processes and/or systems and/or other technologies are deployed. For example, if an implementer determines that speed and accuracy are paramount, the implementer may opt for a mainly hardware and/or firmware vehicle; alternatively, if flexibility is paramount, the implementer may opt for a mainly software implementation; or, yet again alternatively, the implementer may opt for some combination of hardware, software, and/or firmware. Hence, there are several possible vehicles by which the processes and/or devices and/or other technologies described herein may be effected, none of which is inherently superior to the other in that any vehicle to be utilized is a choice dependent upon the context in which the vehicle will be deployed and the specific concerns (e.g., speed, flexibility, or predictability) of the implementer, any of which may vary. Those skilled in the art will recognize that any optical aspects of implementations will typically employ optically-oriented hardware, software, and or firmware.

Those skilled in the art will recognize that it is common within the art to describe devices and/or processes in the fashion set forth herein, and thereafter use engineering practices to integrate such described devices and/or processes into data processing systems. That is, at least a portion of the devices and/or processes described herein can be integrated into a data processing system via a reasonable amount of experimentation. Those having skill in the art will recognize that a typical data processing system generally includes one or more of a system unit housing, a video display device, a memory such as volatile and non-volatile memory, processors such as microprocessors and digital signal processors, computational entities such as operating systems, drivers, graphical user interfaces, and applications programs, one or more interaction devices, such as a touch pad or screen, and/or control systems including feedback loops and control motors (e.g., feedback for sensing position and/or velocity; control motors for moving and/or adjusting components and/or quantities). A typical data processing system may be implemented utilizing any suitable commercially available components, such as those typically found in data computing/communication and/or network computing/communication systems.

The herein described subject matter sometimes illustrates different components contained within, or connected with, different other components. It is to be understood that such depicted architectures are merely exemplary, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “connected”, or “coupled”, to each other to achieve the desired functionality, and any two components capable of being so associated can also be viewed as being “couplable”, to each other to achieve the desired functionality. Specific examples of couplable include but are not limited to physically mateable and/or physically interacting components and/or wirelessly interactable and/or wirelessly interacting components and/or logically interacting and/or logically interactable components.

While particular aspects of the present subject matter described herein have been shown and described, it will be apparent to those skilled in the art that, based upon the teachings herein, changes and modifications may be made without departing from the subject matter described herein and its broader aspects and, therefore, the appended claims are to encompass within their scope all such changes and modifications as are within the true spirit and scope of the subject matter described herein.

Furthermore, it is to be understood that the invention is defined by the appended claims. Although particular embodiments of this invention have been illustrated, it is apparent that various modifications and embodiments of the invention may be made by those skilled in the art without departing from the scope and spirit of the foregoing disclosure. Accordingly, the scope of the invention should be limited only by the claims appended hereto.

It is believed that the present disclosure and many of its attendant advantages will be understood by the foregoing description, and it will be apparent that various changes may be made in the form, construction and arrangement of the components without departing from the disclosed subject matter or without sacrificing all of its material advantages. The form described is merely explanatory, and it is the intention of the following claims to encompass and include such changes.

The invention claimed is:

1. A computer data storage system, comprising:
an attached memory array comprising a plurality of attached memory devices, each attached memory device comprising a permanent memory;
a cache memory array comprising a plurality of cache memory devices providing temporary data storage for the attached memory array;
a storage controller configured for periodically flushing the contents of the cache memory to the permanent memory;
a storage controller further configured for dividing the cache memory array into a plurality of stripes and organizing the stripes into a plurality of windows, wherein each stripe extends across the plurality of cache memory devices and contains at least one block from each cache memory device;
the storage controller further comprising a volume bit register for identifying windows of the cache memory that contain data that has not been flushed to the permanent memory;
the storage controller further comprising a volume mark register indicating logical block addresses (LBAs) corresponding to physical memory locations for the windows;
storage controller further configured to utilize the volume bit register and the volume mark register to rebuild data stored in only those windows that contain data that has not been flushed to the permanent when a power-on-reset (POR) event occurs;
the storage controller further configured to create duplicate copies of the volume bit register and the volume mark register to identify data received while a cache flush event is in progress;
the storage controller further configured to utilize the duplicate copies of the volume bit register and the volume mark register to rebuild cache data that may become corrupted due to a power-off-reset (POR) event occurring during the flush event.

2. The computer data storage system of claim 1, wherein the storage controller implements a RAID storage protocol for the cache memory array.

3. The computer data storage system of claim 1, wherein the storage controller implements a RAID storage protocol for the permanent memory array.

4. The computer data storage system of claim 1, wherein the cache memory devices comprise portions of the attached memory array.

5. The computer data storage system of claim 1, wherein the cache memory devices comprise solid state devices located on a computer card comprising the storage controller.

6. The computer data storage system of claim 1, wherein the storage controller comprises firmware implementing the volume windows system.

7. The computer data storage system of claim 1, further comprising a user interface utility that allows a user to select of a number of stripes included in the windows of the volume windows system.

8. The computer data storage system of claim 1, further comprising a user interface utility that allows a user to enable and disable the volume windows on per-volume basis.

9. A method for maintaining data in a cache memory system, comprising the steps of:
providing an attached memory array comprising a plurality of attached memory devices, each attached memory device comprising a permanent memory;
providing a cache memory array comprising a plurality of cache memory devices providing temporary data storage for the attached memory array;
periodically flushing the contents of the cache memory to the permanent memory;
dividing the cache memory array into a plurality of stripes and organizing the stripes into a plurality of windows, wherein each stripe extends across the plurality of cache memory devices and contains at least one block from each cache memory device;
identifying windows of the cache memory that contain data that has not been flushed to the permanent memory in a volume bit register;
indicating logical block addresses (LBAs) corresponding to physical memory locations for the windows in a volume mark register,
utilizing the volume bit register and the volume mark register to rebuild data stored in only those windows that contain data that has not been flushed to the permanent when a power-on-reset (POR) event occurs;
creating duplicate copies of the volume bit register and the volume mark register to identify data received while a flush event is in progress;
utilizing the duplicate copies of the volume bit register and the volume mark register to rebuild cache data that is potentially corrupted due to a power-off-reset (POR) event occurring during the flush event.

10. The method of claim 9, further comprising the step of implementing a RAID storage protocol for the cache memory array.

11. The method of claim 9, further comprising the step of implementing a RAID storage protocol permanent memory array.

12. The method of claim 9, further comprising the step of configuring the cache memory devices as portions of the attached memory array.

13. The method of claim 9, further comprising the step of configuring the cache memory devices as solid state devices located on a computer card comprising the storage controller.

14. The method of claim 9, further comprising the step of configuring the storage controller with firmware implementing the volume windows system.

15. The method of claim 9, further comprising the step of receiving an indication of a number of stripes in the windows of the volume windows system through a user selection on a user interface utility.

16. The method of claim 9, further comprising the step of receiving an indication of enablement of the volume windows on per-volume basis through a user selection on a user interface utility.

17. A computer system, comprising:
one or more host computers;
an attached memory array comprising a plurality of attached memory devices functionally connected to one or more of the host computers for storing and retrieving I/O data received from the host computers;
a cache memory array comprising a plurality of cache memory devices providing temporary data storage for the attached memory array;
a storage controller configured for periodically flushing the contents of the cache memory to the permanent memory;
a storage controller further configured for dividing the cache memory array into a plurality of stripes and organizing the stripes into a plurality of windows, wherein each stripe extends across the plurality of cache memory devices and contains at least one block from each cache memory device;
the storage controller further comprising a volume bit register for identifying windows of the cache memory that contain data that has not been flushed to the permanent memory;
the storage controller further comprising a volume mark register indicating logical block addresses (LBAs) corresponding to physical memory locations for the windows,
storage controller further configured to utilize the volume bit register and the volume mark register to rebuild data stored in only those windows that contain data that has not been flushed to the permanent when a power-on-reset (POR) event occurs;
the storage controller further configured to create duplicate copies of the volume bit register and the volume mark register to identify data received while a flush event is in progress;
the storage controller further configured to utilize the duplicate copies of the volume bit register and the volume mark register to rebuild cache data that may be corrupted due to a power-off-reset (POR) event occurring during the flush event.

18. The computer system of claim 17, wherein the cache memory devices consist essentially of solid state storage devices; and the attached memory devices consist essentially of hard disc drives.

19. The computer system of claim 17, wherein the storage controller implements a RAID storage protocol for the cache memory array.

20. The computer system of claim 17, wherein the storage controller implements a RAID storage protocol for the permanent memory array.

21. The computer system of claim 17, wherein the cache memory devices comprise portions of the attached memory array.

22. The computer data storage system of claim 1, wherein the cache memory devices comprise solid state devices located on a computer card comprising the storage controller.

23. The computer system of claim 17, wherein the storage controller comprises firmware implementing the volume windows system.

24. The computer system of claim 17, further comprising a user interface utility that allows a user to select of a number of stripes included in the windows of the volume windows system.

25. The computer system of claim 17, further comprising a user interface utility that allows a user to enable and disable the volume windows on per-volume basis.
